(19) United States
(12) Patent Application Publication
(10) Pub. No.: US 2024/0316676 A1
(43) Pub. Date: Sep. 26, 2024

(54) DEVICE AND METHOD FOR CARRYING OUT A WELDING PROCESS

(71) Applicant: Fronius International GmbH, Pettenbach (AT)

(72) Inventors: Dominik SÖLLINGER, Wels-Thalheim (AT); Daniel ITZENBERGER, Wels-Thalheim (AT); Peter LATTNER, Wels-Thalheim (AT)

(73) Assignee: Fronius International GmbH, Pettenbach (AT)

(21) Appl. No.: 18/698,206

(22) PCT Filed: Oct. 17, 2022
(86) PCT No.: PCT/EP2022/078816

§ 371 Date: Apr. 3, 2024

(30) Foreign Application Priority Data
Oct. 19, 2021 (EP) 21203528.1

(51) Int. Cl. B23K 9/167; B23K 9/073; B23K 9/095

(52) U.S. Cl. CPC B23K 9/167; B23K 9/0738; B23K 9/095

(57) ABSTRACT

A welding device for carrying out a TIG welding process, which device enables improved control the welding process. A measuring winding is provided in an ignition device and a second voltage measuring device is provided in the welding device for detecting a measuring winding voltage at the measuring winding; and/or a measuring winding simulation device is provided in the welding device for simulating a virtual measuring winding of the ignition device and for determining a measuring winding voltage at the virtual measuring winding; and a control unit is designed to use the power source voltage and the measuring winding voltage detected by the second voltage measuring device or determined by the measuring winding simulation device to determine a TIG arc voltage at the TIG arc, and is designed to use the determined TIG arc voltage to control the TIG welding process.

The invention relates to a welding device for carrying out a TIG welding process on a workpiece, wherein a welding power source with a first pole and at least one second pole is provided in the welding device, wherein the first pole is electrically connected to a TIG welding torch comprising a non-consumable electrode and the second pole is electrically connectable to the workpiece, wherein an ignition device for generating an ignition voltage for contactless ignition of an arc between the non-consumable electrode and the workpiece is provided in the welding device between the first pole of the welding power source and the non-consumable electrode, wherein a first voltage measuring device for detecting a power source voltage between the first pole and the second pole of the welding power source is provided in the welding device, and wherein a control unit is provided in the welding device which is designed to use the power source voltage to control the welding process. The invention further relates to a method for carrying out a TIG welding process with a non-consumable electrode on a workpiece.

In a conventional TIG (tungsten inert gas) system or in multi-process systems (metal inert gas-MIG and TIG), a voltage measuring unit is required to determine the arc voltage. This voltage measuring unit is usually located in the welding device and measures the voltage between the connection socket for the TIG welding torch and, if applicable, the connection socket for the MIG welding torch and the connection socket for the ground cable. The measured voltage can be used as an approximation of the arc voltage and to control the welding process. A so-called HF (high-frequency) ignition is often used for contactless ignition of an arc between the TIG electrode and the workpiece. A so-called HF ignition device is integrated in the TIG cable, which comprises a coil arrangement which transforms a generally pulsed voltage (of for example up to 2500 V) into a (high) ignition voltage. The ignition voltage ionizes the gas path between the electrode and the workpiece so that an arc is ignited. Depending on the electrode gap, the ignition voltage can range from a few kV up to 20 kV.

However, due to the voltage measurement at the connection sockets, the measured voltage (which is used as the arc voltage) also contains a voltage drop at the HF ignition device, and possibly a voltage drop in the welding cable that leads to the welding torch. The coil arrangement of the HF ignition device generally has a nonlinear inductance-current characteristic curve, and has a very high inductance at low currents in the range of a few amperes. As the current increases, the inductance begins to saturate. This nonlinear behavior has a negative effect on voltage measurement at low currents due to the relatively high voltage drop, which distorts the measurement result, so that in some circumstances the measured voltage will deviate greatly from the actual arc voltage. This has a negative effect on the control of the welding process and in some circumstances will also have a negative effect on the weld seam produced. In order to be able to detect the correct arc voltage during TIG welding, the welding voltage would therefore need to be detected only after the HF ignition device. The problem with this, however, is that the voltage potential of the ignition voltage can be 10 kV or more, and therefore realizing a measuring circuit is not easily possible.

EP 1021269 B1 describes a TIG welding device with an HF ignition device and with a separate voltage measurement at the electrode to detect the arc voltage. A secondary winding for coupling an HF voltage into the welding cable and a measuring winding integrated into the measuring line are provided on the HF ignition device. The measuring winding is used to prevent the HF voltage from penetrating into the power section of the welding power source. The measuring winding consists of a thin, well-insulated cable that is wound together with the secondary winding. The measuring winding and the secondary winding have the same winding direction and the same number of windings. The same voltage is thus induced at the measuring winding and at the secondary winding.

U.S. Pat. No. 2,561,995 A describes an arc ignition and stabilization system which comprises a coupling transformer. A secondary winding for coupling a voltage into the welding circuit, a first primary winding with a relatively small number of windings and a second primary winding with a relatively large number of windings are provided on the coupling transformer. An over-height ratio and an under-height ratio in relation to the arc welding circuit are described.

It is therefore an object of the invention to provide a welding device and a method for carrying out a TIG welding process which enables improved control of the welding process.

According to the invention the object is achieved with the welding device mentioned at the beginning, in that a measuring winding is provided in the ignition device and a second voltage measuring device for detecting a measuring winding voltage at the measuring winding is provided in the welding device and/or in that a measuring winding simulation device for simulating a virtual measuring winding of the ignition device and for determining a measuring winding voltage at the virtual measuring winding is provided in the welding device, and in that the control unit is designed to use the power source voltage and the measuring winding voltage detected by the second voltage measuring device or determined by the measuring winding simulation device to determine a TIG arc voltage at the TIG arc and to use the determined TIG arc voltage to control the TIG welding process. This enables a more precise determination of the TIG arc voltage during TIG welding, which can improve the control of the welding process and consequently the welding quality.

Preferably, the control unit is designed to determine a voltage drop at the secondary winding of the ignition device from the measuring winding voltage and a defined proportionality factor, and to determine the TIG arc voltage from a difference between the power source voltage and the voltage drop. The detected voltage at the measuring winding can thereby be used in a simple manner to calculate the TIG arc voltage of interest.

Preferably, a coil arrangement with a coil core is provided in the ignition device, on which arrangement the secondary winding and the measuring winding are arranged, wherein the number of secondary windings of the secondary winding and the number of measuring windings of the measuring winding are different. The number of measuring windings is here preferably smaller than the number of secondary windings, wherein the number of secondary windings is for example five to ten, particularly preferably seven, and/or the number of measuring windings is preferably at most two, in particular one. Advantageously, a primary winding having a number of primary windings is also arranged on the coil core of the coil arrangement, wherein the number of primary windings is smaller than the number of secondary windings and is greater than or equal to the number of measuring windings, wherein the number of primary windings is preferably two to four, in particular two. A structural design of the ignition device is thereby provided in which an advantageous ratio between the numbers of windings is defined.

The control unit is preferably designed to use a transformation ratio between the number of secondary windings and the number of measuring windings as a proportionality factor to determine the voltage drop of the secondary winding. As a result, the TIG arc voltage can be determined depending on the design of the ignition device.

It can also be advantageous, if the welding device is designed to carry out a MIG welding process, wherein the first pole of the welding power source is connected or can be connected to a MIG welding torch comprising a consumable electrode, preferably via a third connection socket. As a result, a MIG/MAG welding process can also be carried out with the welding device in addition to a TIG welding process. This creates a very flexibly usable welding device.

In the control unit, an analog or digital measurement circuit can advantageously also be provided for determining the TIG arc voltage, wherein a filter for filtering at least one voltage signal is preferably provided in the measuring circuit. Due to the determination according to the invention of the TIG arc voltage on the basis of the relatively low measuring coil voltage, the measuring circuit can be designed for a lower voltage potential. As a result, the measuring circuit can be designed more simply and, due to the shorter required measurement range, a more accurate determination of the measuring winding voltage and consequently of the TIG arc voltage can take place.

It can also be advantageous if a welding current circuit model is stored in the control unit, which model contains a model of the TIG welding cable and/or a model of an MIG welding cable and/or a model of a ground cable and/or a model of the workpiece, and that the control unit is designed to determine a voltage drop in the TIG welding cable and/or in the MIG welding cable and/or in the ground cable and/or at the workpiece by means of the welding current circuit model, and to take into account the determined voltage drop in the determination of the TIG arc voltage, wherein the model of the TIG welding cable and/or the model of the MIG welding cable preferably contain at least one ohmic resistance and at least one inductance. The TIG arc voltage of interest can thereby be determined even more accurately, because possible voltage drops are taken into account.

It can be advantageous if, in the welding device, an additional auxiliary power source is provided for generating an auxiliary voltage for reigniting the TIG arc during the TIG welding process being carried out, in particular the AC welding process, and that the control unit is designed to detect the reignition of the TIG arc on the basis of the determined TIG arc voltage and to deactivate the auxiliary power source when the TIG arc is detected, wherein the detection of the reignition of the TIG arc preferably takes place on the basis of a specified voltage threshold value. The TIG arc voltage determined according to the invention can thereby advantageously be used as an indicator for detecting the TIG arc and subsequently for deactivating the auxiliary power source. As a result, during the polarity reversal process during an AC welding process, undesired overshooting of the welding current can be prevented, whereby unpleasant loud noises can be avoided.

The object is also achieved by a method according to claim 11. Advantageous embodiments of the method are indicated in claims 12 to 15.

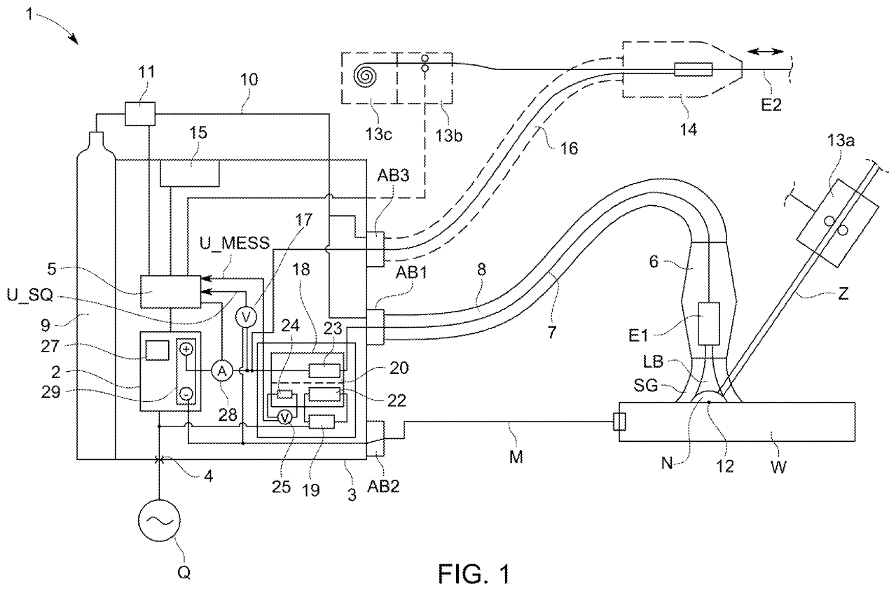

The present invention is described in greater detail below with reference to FIGS. 1 to 8, which show schematic and non-limiting advantageous embodiments of the invention by way of example. In the figures:

FIG. 1 shows a welding device for carrying out a TIG welding process on a workpiece,

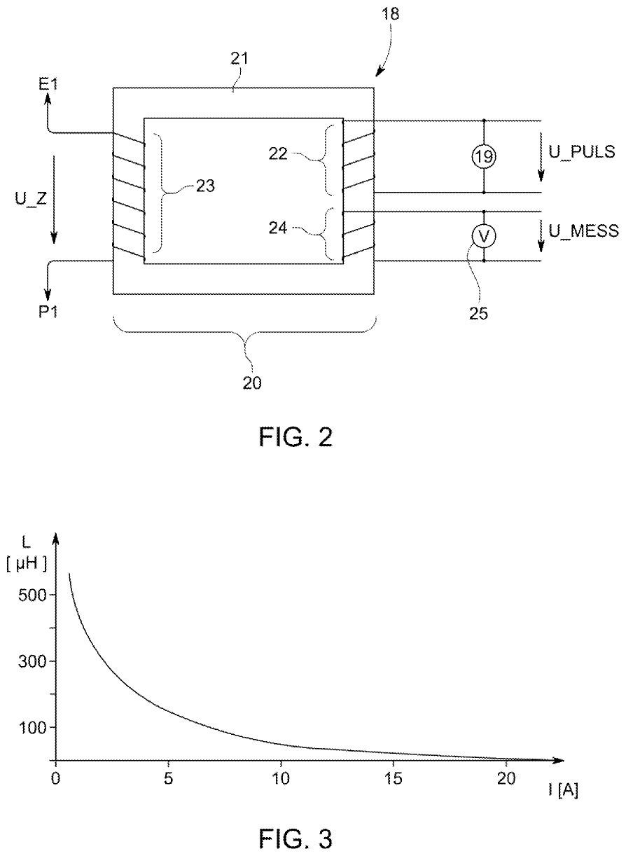

FIG. 2 shows a schematic view of an ignition device,

FIG. 3 shows an exemplary L/I characteristic curve of a secondary winding of the ignition device,

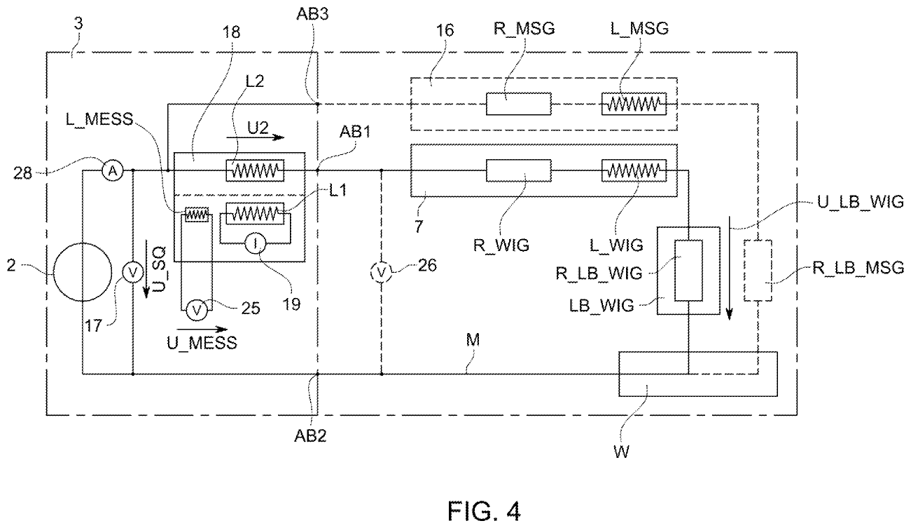

FIG. 4 shows an electrical equivalent circuit diagram of a welding current circuit of the welding device from FIG. 1,

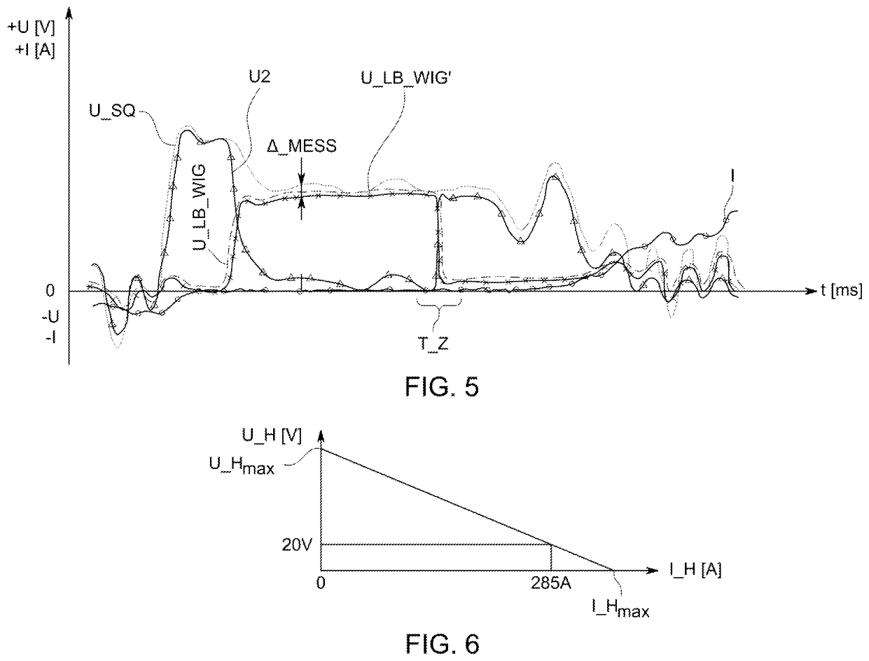

FIG. 5 shows a time curve of electrical welding parameters during a pole reversal process of an alternating current welding process,

FIG. 6 shows an exemplary current/voltage characteristic curve of an auxiliary power source,

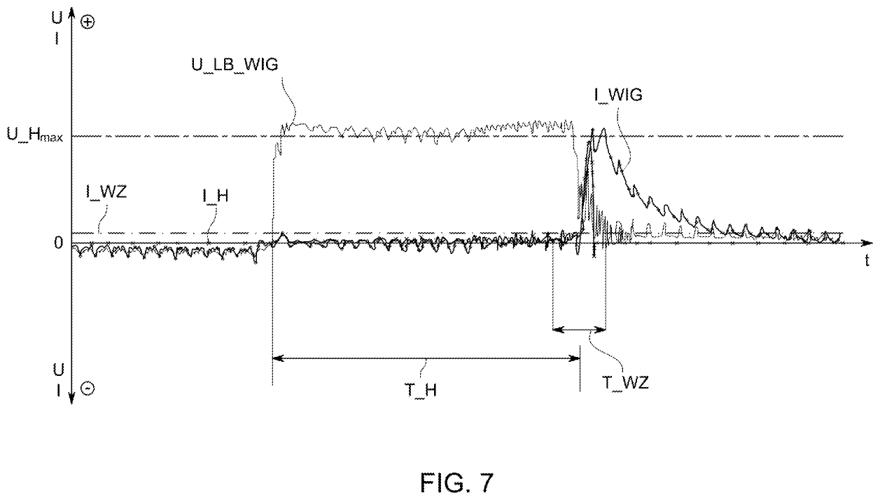

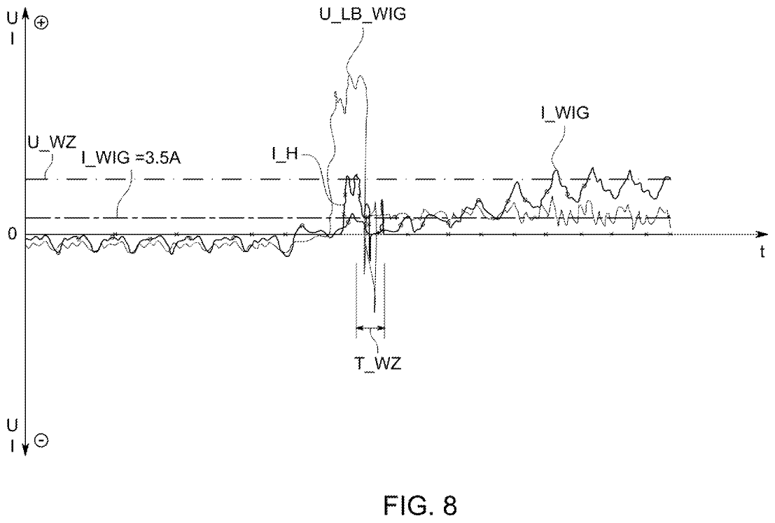

FIG. 7 shows a time curve of electrical welding parameters during a reignition of a TIG arc during an alternating current welding process using an auxiliary power source according to the prior art.

FIG. 8 shows a time curve of electrical welding parameters during a reignition of a TIG arc during an alternating current welding process using an auxiliary power source according to the invention.

FIG. 1 shows a welding device 1 according to the invention for carrying out a welding process in an exemplary embodiment. The welding device 1 shown is designed at least for carrying out a welding process with a non-consumable electrode, i.e. known TIG welding (TIG=tungsten inert gas), wherein a so-called tungsten electrode E1, or also TIG electrode E1, is used as the non-consumable electrode. Optionally, however, the device 1 could also be designed to carry out a MIG/MAG welding process or, in general, metal inert gas welding (MIG) with a consumable MIG electrode E2 in the form of a welding wire, as indicated by the dashed line in FIG. 1. Either a MIG/MAG welding process or a TIG welding process can thus be carried out with the welding device 1, although the two different welding processes do not usually take place simultaneously. The TIG electrode E1 is arranged on a TIG welding torch 6 and the optional MIG electrode E2 (the welding wire) is arranged on a MIG welding torch 14. The welding device 1 shown is designed to carry out a manual welding process in which the TIG welding torch 6 (or the MIG welding torch 14) is manually guided by a welder. Of course, a welding robot (not shown) could also be provided, with which the TIG welding torch 6 and/or the MIG welding torch 14 can be moved automatically according to a predefined movement sequence. The use of a welding robot is well-known, so it is not discussed in more detail below. The core of the invention relates to TIG welding, which is why reference is made to MIG welding only in passing below.

The welding device 1 shown comprises a welding power source 2 in a known manner, which can be provided within a mobile or stationary welding apparatus 3, for example. The welding power source 2 can be supplied with the necessary energy by a power source Q via a suitable electrical connection 4, for example a 3-phase AC connection. The welding power source 2 has a first pole P1 and a second pole P2 in a known manner. The first pole P1 is electrically connected to a first connection socket AB1, and the second pole P2 is electrically connected to a second connection socket AB2. The TIG welding torch 6, which comprises the TIG electrode E1, can be connected to the first connection socket AB1 by means of a welding cable 7. The second connection socket AB2 can be connected via a ground cable M to the workpiece W on which the welding process is to be carried out.

If the welding device 1 is also designed to carry out a MIG welding process, a third connection socket AB3 for connecting a MIG welding torch 14 is preferably also provided, analogous to the first connection socket AB1 for the TIG welding torch 6. The third connection socket AB3 is arranged on the welding apparatus 3 in FIG. 1, for example. Within the scope of the invention, the connection sockets AB1, AB2, AB3 are to be understood not only as a detachable connection but also as a fixed, i.e. non-detachable connection. As a rule, however, detachable, preferably standardized couplings are used as connection sockets AB1, AB2, AB3.

Usually, the first pole P1 of the welding power source 2 is designed as a positive pole and the second pole P2 of the welding power source 2 is designed as a negative pole, as indicated in FIG. 1 by the plus symbol and the minus symbol. In principle, however, a reverse polarity or a polarity reversal of the poles P1, P2 by the welding power source 8 would also be possible during operation of the welding device 1. Via the welding cable 7, the welding power source 2 supplies the TIG welding torch 6 and the TIG electrode E1 provided thereon with the welding current I required for the welding process in a known manner. As is known, the welding cable 7 can also be routed within a hose package 8, in which, in addition to the welding cable 7, further cables and/or pipes and/or hoses can also be provided which are necessary or advantageous for the welding process.

To carry out a TIG welding process, a first electrical potential (usually the positive pole in DC TIG welding) is applied to the workpiece W via the ground cable M and a second electrical potential (usually the negative pole in DC TIG welding) is applied to the TIG electrode E1 via the welding cable 7. In AC TIG welding, on the other hand, the polarities change not only on the workpiece but also on the electrode E1, depending on the frequency of the welding current. The polarities are switched in an inverter 29 using semiconductor technology. During a reversal process (change of polarities), a brief extinguishing of the arc occurs during the zero crossing (welding current I=0). To enable reignition of the arc during AC TIG welding, an additional voltage is applied between the workpiece and the electrode E1 with the aid of an auxiliary voltage source 27. Such an additional auxiliary voltage usually lies between 90V and 500V. After ignition of an arc LB_WIG between the free end of the TIG electrode E1 and a welding point 12 on the workpiece W, a welding circuit is closed and a welding current I flows. Due to the non-consumable electrode E1, it may also be necessary to supply a separate filler material Z to the welding point 12 in order to carry out a TIG welding process (in contrast to MIG/MAG welding with a consumable electrode E2). This filler material can be supplied via a feed unit 13a, not only manually but also mechanically. The arc LB_WIG melts the filler material Z and part of the workpiece W, thereby forming a weld seam N.

In most cases, an (active or inert) shielding gas SG is also used to carry out a welding process to shield the weld pool from the surroundings and to prevent oxidation. The shielding gas SG can be supplied to the TIG welding torch 6 (and optionally to the MIG welding torch 14), for example, from a suitable shielding gas container 9 via a suitable shielding gas line 10, which can also be routed to the TIG welding torch 6 in the hose package 8 (or in a hose package 16 to the MIG welding torch 14). Of course, however, a separate feeding of the shielding gas SG would also be possible. A pressure regulator 11, for example in the form of a cylinder fitting arranged on the shielding gas container, can also be provided to control the flow of the shielding gas SG. Furthermore, a cooling medium for cooling the TIG welding torch 6 can also be supplied via the hose package 8 if necessary (and a cooling medium for cooling the MIG welding torch 14 can also be supplied via the hose package 16 if necessary).

A control unit 5, which can be designed for example as suitable hardware and/or software, is also provided in the welding device 1. The control unit 5 is connected to the welding power source 2 and is designed to control the welding power source 2 to carry out a desired welding process. During the welding process, the control unit 5 controls the welding power source 2 to set certain welding parameters, for example electrical welding parameters such as a welding voltage U, a welding current I, a frequency f of the welding current I, etc. In addition, the control unit 5 may also control other available units of the welding device 1 to set non-electrical welding parameters. For example, the control unit 5 can control the pressure regulator 11 of the shielding gas container 9 to control or regulate a quantity of shielding gas supplied to the welding point 12.

The control unit 5 could also control an optional feed unit 13a for the filler Z to control or regulate a feed rate of the filler Z. The control unit 5 could also control a feed unit 13b of an optionally available MIG welding torch 14 to control or regulate a feed rate of the consumable electrode E2 (of the welding wire). The welding wire can be supplied to the feed unit 13a/13b in a known manner, for example from a wire store 13c. The feed unit 13a/13b including the wire store 13c are shown here as separate units in FIG. 1, but of course they could also be part of the welding device 3. The welding parameters to be set are substantially dependent on the welding process to be carried out, but can generally be regarded as known. Depending on the welding process carried out, the welding parameters can of course vary qualitatively and quantitatively. The control unit 5 can, for example, set a time curve of various welding parameters (e.g. welding current I, welding voltage U, frequency f of the welding current I, etc.) corresponding to a prespecified welding process. For this purpose, the control unit 5 can for example also have one or more suitable controllers in order to regulate one or more welding parameters to a prespecified target value.

In the welding device 1, for example on the welding apparatus 3, a user interface 15 can also be provided which communicates with the control unit 5 in a suitable manner. The user can adjust certain settings via the user interface 15. For example, a particular welding process can be selected and particular welding parameters can be selected and/or set. For example, predefined welding programs with particular preset welding parameters can also be stored in the control unit 5 and can be selected by the user via the user interface 15. If a welding robot is provided in the welding device 1, then the control unit 5 will be able, for example, to communicate with a robot control unit in a suitable manner in order to synchronize the welding process and the movement of the TIG welding torch 6 (or MIG welding torch 14). This communication can also take place, for example, via a higher-level control unit (not shown).

In the welding device 1, here in the welding apparatus 3, a first voltage measuring device 17 is also provided for detecting a power source voltage U_SQ between the first pole P1 and the second pole P2 of the welding power source 2. The first voltage measuring device 17 can be designed as a separate unit, e.g. in the form of a voltmeter, as shown in FIG. 1, but could also be integrated in a suitable manner into the control unit 5. The control unit 5 is designed to use the power source voltage U_SQ to control or regulate the welding process. The control unit 5 can for example calculate one or more control parameters depending on the power source voltage U_SQ received and control the welding power source 2 with the control parameter(s).

Until now, the control unit 5 has used the power source voltage U_SQ, for example, approximatively as a measure for an arc voltage U_LB of interest at the arc LB_WIG (between TIG electrode E1 and welding point 12), using it for example as an actual value for controlling the arc voltage U_LB. For example, a welding voltage U specified in accordance with a desired welding process, or a time curve of a welding voltage U, can be used as the target value. A suitable controller of the control unit 5 can calculate a manipulated variable as a control parameter from the actual value and the target value in accordance with a specific closed-loop control rule. The control unit 5 can then control the welding power source 2 with the determined manipulated variable, for example to set the target value of the welding voltage U and/or the welding current I and/or variables derived from it.

In the welding device 1, there is also provided a (high-frequency) ignition device 18 for generating an ignition voltage U_Z for contactless ignition of the arc LB_WIG between the non-consumable electrode E1 and the workpiece W. Ignition is also understood to mean reignition during the welding process. The ignition device 18 is arranged in the line between the first pole P1 of the welding power source 2 and the TIG welding torch 6 or the TIG electrode E1. In the example shown, the ignition device 18 is arranged in the welding apparatus 3 between the welding power source 2 and the first connection socket AB1. In principle, however, the ignition device 18 could also be arranged between the first connection socket AB1 and the TIG welding torch 6, i.e. outside the welding apparatus 3. In this case, the first voltage measuring device 17 could also detect the power source voltage U_SQ directly between the first connection socket AB1 and the second connection socket AB2.

In FIG. 2, the ignition device 18 is shown in a simplified manner. A coil arrangement 20 with a coil core 21 is provided in the ignition device 18, on which core a primary winding 22, a secondary winding 23 and, according to a preferred embodiment of the invention, an additional measuring winding 24 are arranged. The primary winding 22 is preferably connected to a separate ignition voltage source 19, which can be supplied with the necessary energy by the power source Q shown in FIG. 1, for example. Furthermore, according to the invention a second voltage measuring device 25 is provided for detecting a measuring winding voltage U_MESS at the measuring winding 24. The secondary winding 23 is arranged in the line between the first pole P1 of the welding power source 2 and the TIG electrode E1, in FIG. 1 for example between the first pole P1 and the first connection socket AB1. The primary winding 22 has a defined number of primary windings N1, and the secondary winding 23 has a defined number of secondary windings N2 which is greater than or equal to the number of primary windings N1. The measuring winding 24 described in more detail below has a defined number of measuring windings N_MESS, which is less than or equal to the number of primary windings N1.

The coil arrangement 20 thus has the function of a transformer. If a pulse voltage U_PULS is applied by the ignition voltage source 19 to the primary winding 22, a magnetic flux is generated in the common coil core 21. The temporally variable magnetic flux induces an ignition voltage U_Z in the secondary winding 23 which is proportional to the number N2 of secondary windings of the secondary winding 23. Consequently, the ratio between the ignition voltage U_Z and the pulse voltage U_PULS corresponds approximately to the ratio between the number of secondary windings N2 and the number of primary windings N1, i.e.

$$\frac{U\_Z}{U\_PULS} = \frac{N 2}{N 1} .$$

Analogously, a measuring winding voltage U_MESS is induced in the measuring winding 24, which voltage is proportional to the number of secondary windings N2 of the secondary winding and is proportional to the number of primary windings N1 of the primary winding 22. Consequently, the ratio between the ignition voltage U_Z and the measuring winding voltage U_MESS corresponds approximately to the ratio between the number of secondary windings N2 and the number of measuring windings N_MESS, i.e.

$$\frac{U\_Z}{U\_MESS} = \frac{N 2}{N\_MESS} .$$

The ignition voltage U_Z is coupled into the welding cable 7, and as result the gas between the TIG electrode E1 and the workpiece W is ionized and an arc LB_WIG is ignited. It is known to generate a high voltage within the range of for example 5 kV to 15 KV, depending on the distance between the TIG electrode E1 and the workpiece W, to ionize the gas path. After the arc has been ignited, the ignition voltage U_Z is removed again and the welding process is started or continued. According to an advantageous design of the ignition device 18, the number of secondary windings N2 is for example five to ten, preferably seven, the number of primary windings N1 is for example two to four, preferably two, and the number of measuring windings N_MESS is a maximum of two, preferably one. In the case of a pulse voltage U_PULS=2600V, a number of secondary windings N2=7, a number of primary windings N1=2, and a number of measuring windings N_MESS=1, for example an ignition voltage U_Z=9100V can be generated, and a measuring winding voltage U_MESS is U_MESS=1300V, corresponding to the above relationship. The ignition device 18, in particular the secondary winding 23, acts as a blocking choke in the direction of the welding power source 2, so that the high ignition voltage U_Z cannot damage the sensitive power electronics and the sensor equipment (e.g. the first voltage measuring device 17).

Due to the problems mentioned at the beginning regarding the voltage drop at the ignition device 18, in particular at the secondary winding 23, the use of the power source voltage U_SQ to control the welding process has so far led to unsatisfactory results. As mentioned at the outset, this is due to the nonlinear inductance curve of the ignition device 18, in particular of the secondary winding 23. To illustrate this, an example characteristic curve is shown in FIG. 3. The differential inductance L of the secondary coil 23 is plotted against the current I. It can be seen that the inductance L assumes relatively high values in the range from 200 to over 500 pH at a relatively low current I of 1 to 3 amperes, for example, and that the inductance begins to saturate at higher currents. As a result, when there are low (welding) currents I in the TIG welding cable 7 a relatively high voltage drop occurs at the secondary winding 23. As a result, in some circumstances the power source voltage U_SQ detected by the first voltage measuring device 17 will deviate significantly from the actual arc voltage U_LB at the arc LB_WIG, which has a negative effect on controlling of the welding process.

FIG. 4 shows an equivalent circuit diagram of the welding current circuit of the welding device 1 from FIG. 1. The welding power source 2 can here also include an auxiliary voltage source 27 and an inverter 29 (not shown). The primary winding 22 of the ignition device 18 is shown here as inductance L1, the secondary winding 23 as inductance L2, and the measuring winding 24 as inductance L_MESS. The TIG welding cable 7 is modeled by an ohmic resistance R_WIG and an inductance L_WIG. The TIG arc LB_WIG is also modeled by an ohmic resistance R_LB_WIG. The optional MIG welding cable 16 is modeled by an ohmic resistance R_MSG and an inductance L_MSG, and the MIG arc LB_MSG is also modeled by an ohmic resistance R_LB_MSG.

From the position of the first voltage measuring device 17 in FIG. 4, it can be seen that the detected power source voltage U_SQ not only contains a voltage drop of the TIG welding cable 7, but in particular also a voltage drop of the secondary winding 23 of the ignition device 18, in this case the inductance L2. However, the arc voltage U_LB_WIG at the arc LB is of interest for the most precise possible control of the welding process. It can therefore be seen that using the power source voltage U_SQ to control the welding process can in some circumstances produce unsatisfactory results.

To avoid this, the arc voltage U_LB_WIG could in principle be measured closer to the TIG arc LB_WIG, for example only after the ignition device 18, as indicated in FIG. 4 by the dashed voltage measurement unit 26. However, a direct measurement of the arc voltage U_LB_WIG is not readily possible, because conventional measuring circuits are not designed for high voltages in the range of the ignition voltage U_Z. On the one hand, such high voltages can damage the measuring circuit. On the other hand, it would not be possible to measure the arc voltage U_LB_WIG, which can be in the range of several hundred volts, as accurately as possible during a welding process (i.e. after ignition has already taken place), because the measuring range must be designed for the ignition voltage U_Z, which, as mentioned, lies within the range of several kV.

According to a preferred embodiment of the invention, it is therefore provided that a measuring winding voltage U_MESS is determined at the measuring winding 24 by means of the second voltage measuring device 25, and that the control unit 5 uses the power source voltage U_SQ and the measuring winding voltage U_MESS to determine the arc voltage U_LB_WIG of the arc LB_WIG. The determined arc voltage U_LB_WIG can therefore be used by the control unit 5 instead of the power source voltage U_SQ to control the welding process. According to an alternative embodiment of the invention, it is provided that instead of the measuring winding 24 arranged in the ignition device 18, a measuring winding simulation device for simulating a virtual measuring winding 24 is provided in the welding device 1 (not shown in the figures). In this case, the second voltage measuring device 25 can be omitted, and the measuring winding voltage U_MESS at the virtual measuring winding 24 can be determined by the measuring winding simulation device. The control unit 5 can then use the power source voltage U_SQ and the simulated measuring winding voltage U_MESS to determine the arc voltage U_LB_WIG of the arc LB_WIG.

The measuring winding simulation device is designed to simulate the physically non-existent “real” measuring winding 24 using a virtual measuring winding 24, and to determine the measuring winding voltage U_MESS at the virtual measuring winding 24 from the simulation. The simulation is preferably based on the current flow through the secondary winding 23. In a simple embodiment, the measuring winding simulation device can for example contain a characteristic curve in which the measuring winding voltage U_MESS is mapped as a function of the current at the secondary winding 23. However, the measuring winding simulation device could also contain a characteristic diagram in which the measuring winding voltage U_MESS is mapped as a function of the current at the secondary winding 23 and a further input variable. The characteristic curve or the characteristic diagram can be implemented in the control unit 5 in the form of a look-up table, for example. The characteristic curve or the characteristic diagram could, for example, be determined from measurements previously carried out on a real ignition device 18 comprising a “real” measuring winding 24. However, the measuring winding simulation device could also contain a physical model of the “real” measuring winding 24 in order to analytically determine the measuring winding voltage U_MESS on the basis of physical relationships.

Of course, the measuring winding simulation device could however also be provided in addition to the “real” measuring winding 24 and the second voltage measuring device 25. As a result, for example the measuring winding voltage U_MESS detected by the second voltage measuring device 25 can be checked for plausibility, or a redundant determination of the measuring winding voltage U_MESS can take place. The measuring winding simulation device can for example be integrated into the welding device 1 as separate hardware and/or software and can communicate with the control unit 5 in a suitable manner. Preferably, however, the measuring winding simulation device is integrated in the control unit 5.

Preferably, the control unit 5 determines a voltage drop of the ignition device 18, in particular a voltage drop U2 at the secondary coil 23, from the measured winding voltage U_MESS detected by the second voltage measuring device 25 or simulated by the measuring winding simulation device and a fixed proportionality factor φ, and the arc voltage U_LB_WIG at the TIG arc LB_WIG is determined from a difference between the power source voltage U_SQ and the voltage drop U2 according to U_LB_WIG=U_SQ−U2 where U2=U_MESS*φ.

As already stated, the number of primary windings N1 of the primary winding 22, the number of secondary windings N2 of the secondary winding 23, and the number of measuring windings N_MESS of the measuring winding 24 differ from one another, wherein the number of measuring windings N_MESS is preferably smaller than the number of primary windings N1 and the number of primary windings N1 is smaller than the number of secondary windings N2. In an advantageous embodiment, the number of measuring windings N_MESS=1, the number of primary windings N1=2, and the number of secondary windings N2=7. Advantageously, the control unit 5 can use a transformation ratio j between the number of secondary windings N2 of the secondary winding 23 and the number of measuring windings N_MESS of the measuring winding 24 as a proportionality factor φ to determine the voltage drop U2 of the ignition device 18 or of the secondary winding 23, according to φ=j where

$$j = \frac{N 2}{N\_MESS} .$$

However, the TIG arc voltage U_LB_WIG determined according to the invention still contains the voltage drop of the TIG welding cable 7 and therefore corresponds, based on the system, to a voltage that would be detected by the voltage measuring device 26 shown in dashed lines in FIG. 4. It can therefore be advantageous if a welding circuit model of the welding circuit is stored in the control unit 5 in order to determine at least the voltage drop of the TIG welding cable 7 and to take it into account when determining the TIG arc voltage U_LB_WIG. The welding circuit model preferably contains at least the model of the TIG welding cable and possibly the model of the MIG welding cable, which preferably each contain at least one ohmic resistance R, in this case R_WIG, R_MSG, and at least one inductance L, in this case L_WIG, L_MSG. As a result, the control unit 5 can calculate the voltage drops and take them into account when determining the TIG arc voltage U_LB_WIG, or if applicable the MIG arc voltage U_LB_MSG.

In addition, the welding circuit model could also contain a model of the ground cable M and/or a model of the workpiece W to determine a voltage drop in the ground cable M and/or at the workpiece W and to take it into account when determining the TIG arc voltage U_LB_WIG or, if applicable the MIG arc voltage U_LB_MSG. The modeling of the welding circuit in FIG. 4 is of course only shown by way of example and is simplified. Of course, the design could also be more complex to reproduce the real structure of the welding device 1 as accurately as possible. For example, model parameters of the welding circuit model could also be adjustable and could be set by a user, for example via the user interface 15.

The advantage of determining the TIG arc voltage U_LB_WIG according to the invention is that a measuring circuit only needs to be designed for the voltage potential at the measuring winding 24 and not for the voltage potential of the secondary winding 23, which, as mentioned, can lie within the range of several kV, for example 10 kV. If the ignition device 18 is designed correspondingly (e.g. N2=7, N_MESS=1), the maximum measuring winding voltage U_MESS can be limited to 1300V, for example, during the ignition of the TIG arc LB_WIG and an ignition voltage U_Z=9100V. In normal operation during the welding process (after ignition or between reignitions), the welding voltage U in the TIG welding cable 7 can be 437.5V, for example. The measuring winding voltage U_MESS can consequently be 62.5V, corresponding to the transmission ratio of j=7, and the voltage at the primary winding 22, for a number of primary windings N1=2, can be for example 125V.

Due to the significantly lower voltage potential at the measuring winding 24, for example 1300V, during ignition of the TIG arc LB_WIG compared to the ignition voltage U_Z at the secondary winding 23, a relatively simple circuit with a smaller measuring range can be provided, e.g. in the control unit 5, to determine the TIG arc voltage U_LB_WIG. The measuring circuit can be designed for example as a digital or analog measuring circuit. In a digital measuring circuit, the signals of the power source voltage U_SQ and the measuring winding voltage U_MESS are digitized by an analog/digital (A/D) converter and then digitally subtracted, e.g. by a suitable subtractor. The voltage drop U2 can be calculated from the measuring winding voltage U_MESS before or after the digitization.

However, the TIG arc voltage U_LB_WIG can advantageously also be determined by means of an analog measurement circuit which can contain, for example, a plurality of operational amplifiers (op-amps), subtractors and filters. It is well-known that operational amplifiers have maximum input currents and/or input voltages specified by the manufacturer. In order not to exceed these specified input currents and/or input voltages, it is known that one or more ohmic resistances, so-called compensation resistors, can be connected in series at each input of an operational amplifier. Due to the detection according to the invention of the measurement voltage U_MESS at the measuring winding 24, the advantage results that, due to the lower voltage potential at the measuring winding 24, a lower compensation resistance is required, as a result of which the analog measuring circuit can have a simpler design. The structure and the functioning of such measuring circuits are generally known, so further details are dispensed with here.

FIG. 5 shows a time curve of the welding parameters welding voltage U and welding current I during a pole reversal process of an alternating current (AC) welding process, on the basis of which the advantages of the invention are explained again. As is known, in AC welding the polarity of the welding current I changes between plus and minus during the welding process, as shown by the solid line with the round markers. The power source voltage U_SQ detected by the first voltage measuring device 17 is shown by the solid line with no markers. The voltage drop U2 at the secondary winding 23 of the ignition device 18 determined on the basis of the measuring winding voltage U_MESS (detected by the second voltage measurement device 25) is shown by the solid line with triangular markers. The TIG arc voltage U_LB_WIG′ recorded by means of a measuring device 26 (see FIG. 4) is shown by the solid line with star markers and the TIG arc voltage U_LB_WIG determined according to the invention is shown by the dashed line. The measured TIG arc voltage U_LB_WIG′ is shown here only for comparative purposes and is not carried out in practice due to the disadvantages already described in detail. In the time domain T_Z, the arc LB is reignited, as can be seen by the rapid drop in the measured TIG arc voltage U_LB_WIG′.

The curves in FIG. 5 clearly show that the power source voltage U_SQ differs greatly from the measured TIG arc voltage U_LB_WIG′ during the pole reversal process due to the low welding current I in the zero-crossing range (of 1 to 5 A, for example). This is due to the non-linear relationship between the inductance 12 of the secondary winding 23 and the welding current I and the resulting voltage drop U1, as already described using the characteristic curve in FIG. 3. In contrast, the non-linear characteristic curve of the secondary winding 23 has a much smaller effect at higher currents I, for example >10 A, because the inductance 12 and consequently the voltage drop U2 are substantially lower due to the saturation. Measurements have shown that a deviation Δ_MESS between the measured power source voltage U_SQ and the measured TIG arc voltage U_LB_WIG′ correlates very well with the voltage drop U2 at the secondary winding 23, as indicated in FIG. 5.

A difference between the measured power source voltage U_SQ and the determined voltage drop U2 therefore correlates very well with the measured TIG arc voltage U_LB_WIG′, as can be seen from the dashed line. The arc voltage U_LB_WIG determined in this way can therefore be used as the TIG arc voltage of interest U_LB_WIG for controlling the welding process. As already described, the TIG arc voltage U_LB_WIG is determined on the basis of the measuring winding voltage U_MESS at the measuring winding 24 detected by the second voltage measuring device 25 and the proportionality factor φ, where the proportionality factor φ preferably corresponds to the transformation ratio i.

According to a further advantageous embodiment of the invention, at least one additional auxiliary power source 27 for generating an auxiliary voltage U_H is provided in the welding device 1. The auxiliary power source 27 can here be designed for example as an (ideal) voltage source or (ideal) power source. The auxiliary voltage U_H is used to reignite the TIG arc LB_WIG during the TIG welding process that is being carried out. As a rule, such auxiliary power sources 27 are used in AC welding processes in order to briefly generate a relatively high welding voltage, in the range of 90V-500V, in the welding circuit during the pole reversal process at the zero crossing of the welding current I, thus enabling or supporting the reignition of the TIG arc LB_WIG. After the reignition of the TIG arc LB_WIG, the auxiliary power source is deactivated again as quickly as possible.

As is known, a welding transformer (not shown) can be provided in the welding power source 2 for generating the welding voltage required for the welding process; in the context of the present disclosure, for example, for generating the power source voltage U_SQ between the first pole P1 and the second pole P2. The auxiliary voltage source 27 can, for example, be designed as an additional winding of the welding transformer with a different transformation ratio. The higher auxiliary voltage U_H relative to the welding voltage U or power source voltage U_SQ can be generated by the transformation ratio. After rectification and, for example, a switchable IGBT (bipolar transistor with insulated gate electrode) or MOSFET (metal-oxide semiconductor field-effect transistor), the auxiliary voltage U_H can for example be connected to the connection sockets AB1, AB2 of the welding device 1.

An exemplary current-voltage characteristic curve of an auxiliary power source 27 is shown in FIG. 6. It can be seen here that a substantially linear relationship between the auxiliary voltage U_H and the auxiliary current I_H results. The maximum auxiliary voltage U_Hₘₐₓ at an auxiliary current of I_H=0 can be in the range of 270V, for example, and the maximum auxiliary current I_Hₘₐₓ at an auxiliary voltage U_H=0 can be in the range of 300 A or more, for example. The structure and the function of such auxiliary power sources 27 are basically known in the prior art, so a detailed description is omitted here. In FIG. 1, the auxiliary power source 27 is only schematically indicated as part of the welding power source 2.

FIG. 7 shows a diagram with a time curve of the welding current I_WIG, the arc voltage U_LB_WIG at the TIG arc, and the auxiliary voltage U_H during a pole reversal process of an AC welding process using an auxiliary power source 27. The curve shown corresponds to the prior art. The solid line with no markers symbolizes the arc voltage U_LB_WIG at the TIG arc LB_WIG, the solid line with cross-shaped markers symbolizes the auxiliary current I_H of the auxiliary power source 27, and the solid line with round markers symbolizes the welding current I_WIG. In the depicted auxiliary energy time range T_H, the auxiliary power source 27 is activated but no arc has yet been ignited, so that there is a very high ohmic resistance in the welding circuit. The auxiliary energy time range T_H can be in the range of 250 μs, for example. The arc voltage U_LB_WIG thus substantially corresponds to the maximum auxiliary voltage U_Hₘₐₓ of the auxiliary power source 27 in the auxiliary energy time range T_H, e.g. in the range of 270V.

At the end of the auxiliary energy time range T_H, here in the (re)ignition time range T_WZ shown, the arc LB_WIG is ignited, which can be recognized by a very rapid drop in the arc voltage U_LB_WIG, for example to below 30V. At the same time, the welding current I_WIG and also the auxiliary current I_H rapidly increase. It is known that the aim is to switch off the auxiliary voltage U_H as quickly as possible after ignition of the arc LB_WIG by deactivating the auxiliary power source 27. Until now, a fixed (re)ignition current level I_WZ has been used to detect the arc LB_WIG and the auxiliary power source 27 was deactivated when the ignition current level I_WZ was reached. FIG. 7 shows an exemplary ignition current level I_WZ, which can be for example 35A, in the form of a dash-dotted horizontal line. The welding current I_WIG can for example be detected by means of the current measuring device 28 shown in FIG. 1 and FIG. 4, and the control unit 5 can deactivate the auxiliary power source depending on the detected welding current I_WIG and the specified ignition current level I_WZ.

FIG. 7 shows that the welding current I_WIG overshoots up to 42 A, for example, with a very high rate of current increase, despite the selected switch-off criterion of I_Z=35 A. This steep rise in current leads to an acoustically very loud polarity reversal process, which is usually perceived as unpleasant by the welder. The relationship can also be derived from the U/I characteristic curve of the auxiliary power source 27 (FIG. 6), where it can be seen that, at a low auxiliary voltage U_H of for example 20V, a very high auxiliary current I_H of for example 285A results, which results in the rapid rise of the welding current I_WIG after the ignition of the arc LB_WIG. It can thus be seen that it is advantageous to detect the ignition of the arc LB_WIG as early as possible in order to be able to deactivate the auxiliary power source 27 as quickly as possible. However, lowering the ignition current level I_WZ to even lower values is not expedient, as in some circumstances this cannot guarantee the (re)ignition of a stable arc LB_WIG.

According to an advantageous embodiment of the invention, the welding current I_WIG is therefore no longer used to detect the arc LB_WIG; rather, the arc voltage U_LB_WIG determined according to the invention is used, as explained with reference to FIG. 8. Analogously to FIG. 7, FIG. 8 shows a diagram with a time curve of the welding current I_WIG (solid line with round markers), the arc voltage U_LB_WIG at the TIG arc (solid line without markers), and the auxiliary current I_H of the auxiliary power source 27 during a pole reversal process of an AC welding process (solid line with cross-shaped markers). Again, the (re)ignition of the arc LB_WIG takes place in the (re)ignition time range T_WZ, which can be recognized by the rapid drop in the arc voltage U_LB_WIG.

In contrast to the prior art according to FIG. 7, here the (re)ignition of the LB_WIG arc is detected on the basis of the arc voltage U_LB_WIG (determined on the basis of the measured winding voltage U_MESS) of the LB_WIG arc, and no longer using the welding current I_WIG. The arc voltage U_LB_WIG can be used as a more accurate indicator of the ionization of the gas path between the TIG electrode E1 and the workpiece W. The control unit 5 can detect the (re)ignition of the TIG arc LB_WIG, for example, using a specified (re)ignition voltage level U_WZ, which can for example be in the range from 10V to 113V. FIG. 8 shows an exemplary ignition voltage level U_WZ=45V in the form of a dash-dotted horizontal line. It can be seen that the auxiliary power source 27 is deactivated substantially earlier here, i.e. at a significantly lower welding current I_WIG of e.g. 3.5 A, which means that the welding current I_WIG does not overshoot significantly as in FIG. 7. The polarity reversal process is therefore substantially quieter, and is no longer perceived as disturbing by the welder. As an alternative to detecting the reignition of the TIG arc LB_WIG on the basis of the specified ignition voltage level U_WZ, a specified time gradient dU_LB_WIG/dt could also be used as a condition for detecting the reignition of the TIG arc LB_WIG, for example.

In some cases, however, the specified ignition voltage level U_WZ could for example also be reached or exceeded in an undesirable manner, so that in some circumstances the ignition voltage level U_WZ will not be sufficient as the sole indicator for the reignition of the TIG arc LB_WIG. This case can occur, for example, if a self-induction voltage is induced in the welding current circuit. This can be the case, for example, if the TIG welding cable 7 and/or the ground cable M crosses the welding cable of another welding device (or another current-carrying cable) or is arranged in close spatial proximity to it, for example in parallel in some sections. A voltage, the so-called self-induction voltage, can be induced in the TIG welding cable 7 and/or the ground cable M of the welding device 1 in question by a time-varying current in the other welding cable (or the other current-carrying cable). If this self-induction voltage reaches or exceeds the specified ignition voltage level U_WZ, a reignition of the TIG arc LB_WIG could be falsely detected, although it has not actually taken place. This can advantageously be avoided if, in addition to the predefined ignition voltage level U_WZ, a predefined (re)ignition current level I_WZ of the auxiliary voltage source 27 is used (as explained with reference to FIG. 7). As a result, the ignition current level I_WZ can be used to verify the reignition of the TIG arc LB_WIG.

1. A welding device for carrying out a TIG welding process on a workpiece, wherein a welding power source with a first pole and at least one second pole is provided in the welding device, wherein the first pole is electrically connected to a TIG welding torch comprising a non-consumable electrode and the second pole is electrically connectable to the workpiece, wherein an ignition device for a contactless ignition of a TIG arc between the non-consumable electrode and the workpiece is provided in the welding device, which ignition device has a secondary winding for coupling an ignition voltage into a TIG welding cable, wherein a first voltage measuring device for detecting a power source voltage between the first pole and the second pole of the welding power source is provided in the welding device, and wherein a control unit is provided in the welding device, which control unit is designed to use the power source voltage to control the TIG welding process, wherein a measuring winding is provided in the ignition device and a second voltage measuring device for detecting a measuring winding voltage at the measuring winding is provided in the welding device and/or wherein a measuring winding simulation device for simulating a virtual measuring winding of the ignition device and for determining a measuring winding voltage at the virtual measuring winding is provided in the welding device and wherein the control unit is designed to use the power source voltage and the measuring winding voltage detected by the second voltage measuring device or determined by the measuring winding simulation device to determine a TIG are voltage at the TIG arc and to use the determined TIG arc voltage to control the TIG welding process.

2. The welding device according to claim 1, wherein the control unit is designed to determine a voltage drop at the secondary winding of the ignition device from the measuring winding voltage and from a defined proportionality factor and to determine the TIG are voltage from a difference between the power source voltage and the voltage drop.

3. The welding device according to claim 2, wherein a coil arrangement with a coil core is provided in the ignition device, on which arrangement the secondary winding and the measuring winding are arranged, wherein a number of secondary windings of the secondary winding and a number of measuring windings of the measuring winding are different.

4. The welding device according to claim 3, wherein the number of measuring windings is smaller than the number of secondary windings, wherein the number of secondary windings is preferably five to ten, particularly preferably seven, and/or the number of measuring windings is preferably a maximum of two, in particular one.

5. The welding device according to claim 3, wherein a primary winding with a number of primary windings is arranged on the coil core of the coil arrangement, wherein the number of primary windings is smaller than the number of secondary windings and is greater than or equal to the number of measuring windings, wherein the number of primary windings is preferably two to four, in particular two.

6. The welding device according to claim 3, wherein the control unit is designed to use a transformation ratio between the number of secondary windings and the number of measuring windings as a proportionality factor for determining the voltage drop of the secondary winding.

7. The welding device according to claim 1, wherein the welding device is designed to carry out a MIG welding process, wherein the first pole of the welding power source is connected or connectable to a MIG welding torch comprising a consumable electrode.

8. The welding device according to claim 1, wherein an analog or digital measuring circuit for determining the TIG are voltage is provided in the control unit, wherein a filter for filtering at least one voltage signal is preferably provided in the measuring circuit.

9. The welding device according to claim 1, wherein a welding circuit model is stored in the control unit, which model contains a model of the TIG welding cable and/or a model of a MIG welding cable and/or a model of a ground cable and/or a model of the workpiece, and in that the control unit is designed to determine a voltage drop in the TIG welding cable and/or in the MIG welding cable and/or in the ground cable M and/or on the workpiece W using the welding circuit model and to take the determined voltage drop into account, when determining the TIG arc voltage on the TIG arc and/or a MIG arc voltage on the MIG arc, wherein the model of the TIG welding cable and/or the model of the MIG welding cable preferably contains at least one ohmic resistance and at least one inductance.

10. The welding device according to claim 1, wherein an additional auxiliary power source for generating an auxiliary voltage for reigniting the TIG arc during the TIG welding process, in particular AC welding process, is provided in the welding device, and in wherein the control unit is designed to detect the reignition of the TIG arc on the basis of the determined TIG are voltage and to deactivate the auxiliary power source, when the TIG are is detected, wherein the detection of the reignition of the TIG arc preferably takes place on the basis of a specified voltage threshold value.

11. A method for carrying out a TIG welding process with a non-consumable electrode on a workpiece, wherein the non-consumable electrode is electrically connected via a TIG welding cable to a first pole of a welding power source and the workpiece is electrically connected to a second pole of the welding power source, wherein an ignition voltage is coupled into the TIG welding cable by a secondary winding of an ignition device to ignite a TIG arc between the non-consumable electrode and the workpiece without contact, wherein a power source voltage is detected between the first pole and the second pole of the welding power source, and wherein the detected power source voltage is used by a control unit to control the TIG welding process, wherein a measuring winding voltage is detected at a measuring winding provided in the ignition device, or in that a virtual measuring winding of the ignition device is simulated by a measuring winding simulation device and a measuring winding voltage is determined at the virtual measuring winding, and in that the control unit uses the power source voltage and the detected or determined measuring winding voltage to determine a TIG arc voltage at the TIG are and uses the determined TIG arc voltage to control the TIG welding process.

12. The method according to claim 11, wherein the control unit determines a voltage drop at the secondary winding from the measuring winding voltage and a proportionality factor and determines the TIG are voltage from a difference between the power source voltage and the voltage drop.

13. The method according to claim 12, wherein the control unit uses a transformation ratio between a number of secondary windings of the secondary winding and a number of measuring windings of the measuring winding as a proportionality factor for determining the voltage drop, wherein the TIG arc voltage is determined by the control unit, preferably by an analog or digital circuit.

14. The method according to claim 11, wherein a voltage drop in the TIG welding cable and/or a voltage drop in a ground cable and/or a voltage drop at the workpiece is determined by a welding circuit model stored in the control unit, and in that the control unit takes the determined voltage drop into account when determining the TIG are voltage, wherein the welding circuit model preferably contains at least one ohmic resistance and at least one inductance.

15. The method according to claim 11, wherein an auxiliary voltage is generated by an additional auxiliary power source to reignite the TIG arc during the TIG welding process carried out, and in that the control unit detects the reignition of the arc on the basis of the determined TIG arc voltage and deactivates the auxiliary power source, when the TIG arc is detected, wherein the detection of the reignition of the TIG arc preferably takes place on the basis of a specified voltage threshold value.
